(19) United States
(12) Patent Application Publication
(10) Pub. No.: US 2009/0018829 A1
(43) Pub. Date: Jan. 15, 2009

(54) Speech Recognition Dialog Management

(75) Inventor: Michael Kuperstein, Wellesley, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: METAPHOR SOLUTIONS, INC., Wellesley, MA (US)

(21) Appl. No.: 11/629,034

(22) PCT Filed: Jun. 8, 2005
(86) PCT No.: PCT/US2005/020174

§ 371 Date: Aug. 22, 2008

Related U.S. Application Data
(60) Provisional application No. 60/578,031, filed on Jun. 8, 2004.

(51) Int. Cl. G10L 15/26; G10L 15/18

(52) U.S. Cl. 704/235; 704/257; 704/270.1; 704/E15.001; 704/E15.003; 704/E15.043

(57) ABSTRACT

Described is a speech recognition dialog management system that allows more open-ended conversations between virtual agents and people than are possible using just agent-directed dialogs. The system uses both novel dialog context switching and learning algorithms based on spoken interactions with people. The context switching is performed through processing multiple dialog goals in a last-in-first-out (LIFO) pattern. The recognition accuracy for these new flexible conversations is improved through automated learning from processing errors and addition of new grammars.

### RELATED APPLICATION

This application claims the benefit of U.S. Provisional Application No. 60/578,031, filed on Jun. 8, 2004. The entire teachings of the above application are incorporated herein by reference.

### BACKGROUND OF THE INVENTION

Directed dialogs have been commercially successful for short dialogs. One of the major barriers to increasing the flexibility of dialogs results from a critical feature of many of the existing speech recognition engines, which recognize speaker independent continuous speech without prior training based on an exhaustive list of expected phrases or phrase combinations. Such a list of expected phrases is referred to as a finite state speech grammar. If a user says an utterance that is not on this list, the engine will not be able to recognize what the user said.

There have been attempts to develop systems that allow flexible dialogs or natural conversation using different approaches. One commercially successful but limited approach uses statistical language models (SLM) in speech grammars. In this approach, many thousands of audio utterances and their transcribed text are learned through SLM processing (See C. D. Manning, H. Schutze, Foundations of Statistical Natural Language Processing, MIT Press, Cambridge, Mass., 1999). SLM speech recognition processing has been successful in call routing applications where an incoming call is routed to one of many departments in a large corporation with one phone number. The application allows the user to say anything when asked “How may I help you?” and is able to understand and accommodate almost all responses for routing the call correctly. However, that solution is very time consuming and very costly to implement, costing hundreds of thousands of dollars. This is because it requires collecting and manually transcribing thousands of recorded calls to live agents. Moreover, the solution is only applied to one question at the beginning of the dialog. True flexible dialogs need to allow natural conversation at every turn of dialog.

Another approach has been attempted by a consortium of companies involved in the MIT Galaxy Communicator program sponsored by DARPA IAO. Using Galaxy, MIT has set up an example airline reservation speech application, called Mercury, that tried to allow natural conversation at every dialog turn (See S. Seneff, Response planning and generation in the Mercury flight reservation system, MIT Laboratory of Computer Science, Spoken Languages Systems Group, Cambridge, Mass., 2002). Their approach combined SLM speech recognition with semantic processing and a set of dialog transaction rules for the application. On tests by NIST, Mercury obtained a substantially better than “Neutral” ranking on the user survey point of “I would like to use this system regularly.”

Although user tests of the Mercury system had decent results as tested by NIST, the system would be difficult to generalize to other speech applications or be commercialized. This is because of the following factors: the semantic parser is designed only to work for this particular application; the dialog management rules are only designed for this one application, and the system only works with the MIT speech recognition engine. All the interface protocols are homegrown making it very difficult to commercialize. Since the Communicator project got started, the commercial speech systems have progressed rapidly in standardizing speech recognition interfaces and have diverged from the protocols of the Galaxy Communicator program.

### SUMMARY OF THE INVENTION

Embodiments of the present invention include a highly flexible speech recognition dialog management method and system using both novel dialog context switching and learning algorithms.

Billions of dollars are spent servicing customers using live agents. Speech recognition solutions have automated a small portion of these calls using directed dialogs, where a virtual agent asks the user questions and the user responds only to those questions. Although this works for short service calls like PIN reset and cash transfers, it might not work for long conversations, such as, for example, problem resolution and plan negotiations, where additional conversational flexibility is required. In one embodiment of the invention, flexible dialog processing is used to allow for a more open-ended conversation between a virtual agent and a user. Not only does the virtual agent guide the user through a transaction, but it also allows the user to ask unexpected, but relevant questions, change his mind, and consider “what-if” topics.

In one embodiment of the invention, novel learning of speech grammars is employed by using automated semantic analysis of recognition errors made during user interactions. The recognition and/or detection accuracy for these new flexible conversations is expected to be equal to today's commercial systems that only deliver directed dialogs.

For call centers, implementation of various aspects of the present invention may allow many more types of customer service to be automated over the phone, saving billions of dollars in labor costs. For society, it may contribute to changing how people access knowledge and perform transactions, making it easier, faster and more productive to interact with society's knowledge, medical and financial infrastructure.

Almost all the spoken dialog processing done commercially today uses directed dialog, in which a virtual agent asks the user questions and the user responds only to those questions. Although this approach is useful for short dialogs like resetting your PIN, it is too rigid for longer conversations. Because a dialog is a serial process, it only takes one recognition fault to stop the dialog from completing. The longer the conversation, the higher the chance that the user will say something that speech grammar cannot recognize. So it is very important that the dialog be highly flexible to accommodate whatever the user says.

For example, in the middle of a phone shopping session, the computer may ask “Which type of ink cartridge do you want to buy?” Rather than directly answer the question, the user may instead want to know: “What are the prices of the most popular brands?” With directed dialog, the computer may simply repeat the question, because it expects an answer from a list of ink cartridges, which may not match anything the user has said. But because the user may believe that he asked a perfectly valid question, he may feel frustrated that the computer did not recognize what he asked and probably just hang up.

When people speak to other people, they often intersperse a conversation with a number of unexpected turns of conversation like answering a question with a question, abruptly changing topics, changing their mind, wondering about “what-if” topics or challenging an assertion. One aspect of the present invention includes novel processes for spoken dialog which will better accommodate the flexible way people naturally converse.

The dialogs may be controlled by conducting a conversation between a user and a virtual agent according to a first script to satisfy a first goal with a meaning category of a speech grammar. When an utterance is received from a user, it may be recognized using focus grammar and orienting grammar, the former being used to recognize one of the expected responses and the letter being used to recognize one of a set of questions or topic change commands related to a subject of the conversation. If the utterance matches a phrase in the orienting grammar, the processing may proceed to a second script to satisfy a second goal, while the first script is stored in memory. Later, the conversation may return to the first script.

If the utterance received from the user fails to match a phrase in the existing speech grammar, resulting in a speech matching error, the system may adaptively learn from such errors by updating the speech grammar within one or more meaning categories to include an additional phrase that corresponds to a part or all of the user utterance. The speech grammar may be a finite state grammar or a statistical language model grammar.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a system diagram of the Metaphor Conversation Manager process flow for transaction over the phone or on a PC;

FIG. 2 illustrates a context stack using a LIFO (last-in-first-out) access methodology;

FIG. 3 is a flow chart of a procedure for changing context during a dialog;

FIG. 4 is a flow chart of a procedure for adding new entries to focus or orienting grammars based on processing recognition errors.

### DETAILED DESCRIPTION OF THE INVENTION

Although SLM speech recognition engines have been used in research projects for flexible dialogs, it takes an enormous manual effort and expense to realize the flexible result they promise. The effort includes recording, transcribing, analyzing and mapping thousands of human conversations for each prompt of a dialog. One embodiment of the present invention provides another alternative that uses readily available speech recognition engines. More flexibility is gained through using commercially available speech recognition engines and leveraging higher level dialog context and semantic knowledge.

Aspects of the present invention not only allow development of technology for flexible dialog processing, but also allow the development of the technology to the point where it becomes easy to develop, without much expense, while being as accurate as today's commercial but inflexible systems. To accomplish this goal of easy development requires as much automation of the development process as possible. Finite state speech engines are already very accurate. In one embodiment of the invention, their use may be made much more flexible by automatically learning new finite state grammars through user interactions. The learning includes processing the recognition errors from user interactions into newly added induced finite state or statistical language model (SLM) grammars to provide the needed flexibility.

One embodiment of the present invention extends a foundation of dialog management processing that has already been built called Metaphor Conversation Manager (Metaphor CM) as described in U.S. patent application Ser. No. 60/510,699, PCT application PCT/US2004/033186, and a U.S. patent application filed on Jun. 3, 2005, attorney docket no. 3554.1000-004, the entire contents of which are incorporated herein by reference. It is an integrated development environment (IDE) for developing automated speech applications that interact with callers, interact with data sources and with live agents through Automated Call Distributors (ACDs) in case the call is transferred. Metaphor CM is an editor, linker, debugger and run-time interpreter that dynamically generates voice gateways scripts in Voice XML and SALT from a high-level language, such as, for example, C#, C, C++, VB.NET, VB, Java, JavaScript, Jscript, etc. The Metaphor CM is as easy to use as writing a flowchart with many inherited resources and modifiable properties that allows unprecedented speed in development. In an alternative embodiment of the invention, a different dialog development and/or processing system may be used in conjunction with learning from errors in processing, as deemed appropriate by one of skill in the art.

### Features of Metaphor CM

One or more of the features described herein may be present in an alternative conversation manager to be used with alternative embodiments of the present invention.
An intuitive high level scripting tool that speech-interface designers and developers can use to create, test and deliver speech applications.
Dialog design structure based on real conversations instead of a sequence of forms. This allows for much easier control of process flow where there are context dependent decisions.
Reusable dialog modules and a framework that encourages speech application teams to leverage developed business applications across multiple speech applications in the enterprise and share library components across business units or partners.
Runtime debugger is available for text simulations and voice dialogs.
Handles many speech application exceptions automatically.
Allows call logging and call analysis.
Support for multiple speech recognition engines that work underneath an open-standard interface like Voice XML and SALT.

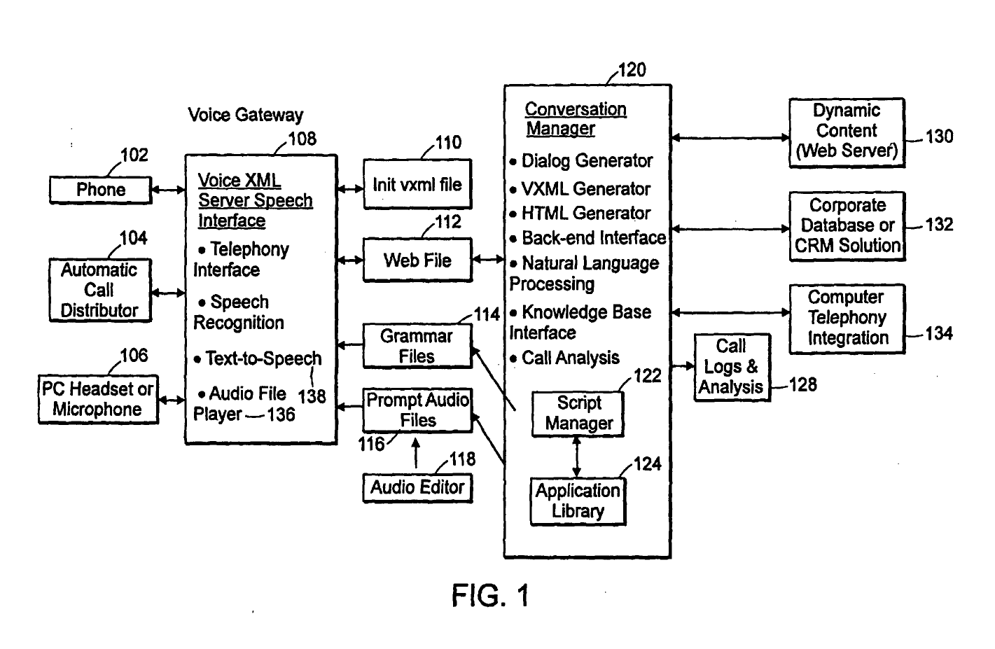

A typical process flow for transactions either over the phone or on a PC is illustrated in the system diagram of FIG. 1. Such process flow may take place, for example, in Metaphor CM.

The run time process proceeds in several stages. In the first stage, a user places a call to a Metaphor speech application using, for example, telephone 102, automatic call distributor 104, or personal computer interface 106.

In the second stage, voice gateway 108 picks up the call and maps the phone number of the call to an initial Voice XML file. In an alternative embodiment of the invention, other mapping mechanisms may be used, as deemed appropriate by one skilled in the art.

The initial Voice XML file then submits a web request to the web file 112 (step 110).

The web file 112 initializes administrative parameters and calls the conversation manager 120. The conversation manager 120 interacts with application libraries designed to process a series of dialog plans and manages controls for interfacing to the user, databases, web and internal dialog context to achieve the joint goals of the user and the virtual agent. The script manager and compiled application libraries are described in a U.S. patent application Ser. No. filed on Jun. 3, 2005, attorney docket number 3554.1000-004, in further detail, which is incorporated herein by reference in its entirety. The application libraries may be compiled from scripts written in a high level programming language, such as, for example, C#, C++, C. Java, Jscript, JavaScript, VB.NET or other standard or proprietary computer language. When application library 124 processes a plan for a user interface, it delivers the prompt, speech grammar 114 and audio files 116 needed for one turn of conversation to the media gateway 108 for an exchange with the user. The application library may be a stand-alone application, a dynamically linked library, a built in function, or any other software component as implemented by one of skill in the art.

The application library 124 generates Voice XML on the fly as it processes the user input. After the first input, the application library 124 is initialized and it acts according to the first plan. The first plan provides the first prompt and reference to any audio and speech recognition speech grammar files 114 for the user interface. The application library 124 formats the dialog interface into Voice XML and returns it to the Voice XML server in the voice gateway 108. The Voice XML server processes the request through its audio file player 136 and text-to-speech player 138 if needed and then waits for the user to respond. When the user is done speaking, his speech is recognized by the voice gateway 108 using the speech grammar 114 provided and the recognized result is submitted again to the web file 112. The rest of the conversation proceeds according to the steps outlined above.

If at any time the conversation manager needs to get or set data externally, it may interface to web services 130, CTI 134, CRM 132 solutions and databases either directly or through custom COM+ data interfaces. An ODBC interface may be used from an application library directly to any popular database.

If call logging is enabled, the user audio, dialog prompts used are stored in call database 128 and the call statistics for the application are incremented during a session. Detail and summary call analyses may also be stored in database 128 for generating customer reports.

Implementations of Metaphor conversations are extremely fast to develop because the developer never writes any Voice XML or SALT code and many exceptions in the conversations are handled automatically.

### Context Switching in Flexible Dialogs

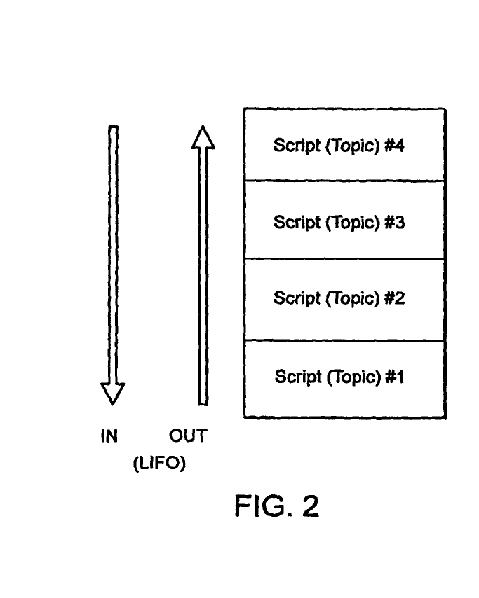

Context switching is performed in a last-in-first-out (LIFO) fashion, as illustrated in FIG. 2. In an alternative embodiment of the invention, the user may be allowed to “jump levels” in the conversation, thus returning to some previous turn of conversation without finishing the dialogs in the subsequent turns of conversation.

In one embodiment of the invention, context switching may be achieved using both focus and orienting grammars that are concurrently active. Focus grammar may be used to recognize a response that is one of the expected responses to a prompt from a virtual agent, while orienting grammar may be used to recognize a possible topic change.

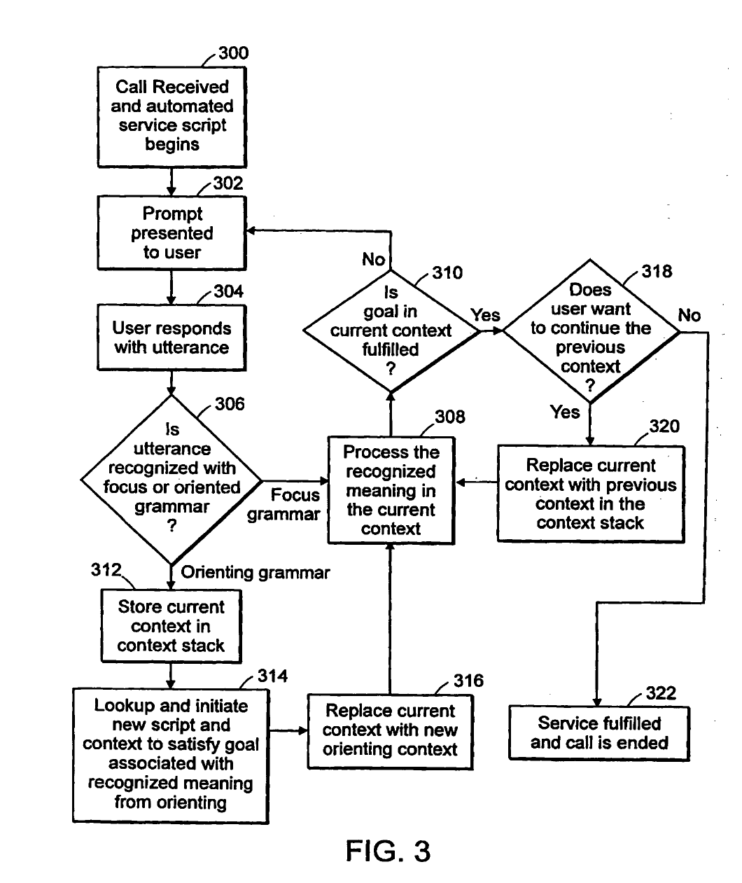

The following steps, as shown in FIG. 3, are involved in processing a conversation:
When a call first comes in, the media or voice gateway starts the conversation manager 120, which, in turn, initializes an appropriate application library or script (Step 300).
After the conversation manager 120 delivers a prompt to the user (Step 302), the user then responds (Step 304) and the speech grammar recognizes both what the user said and whether it came from the focus or orienting grammar (Step 306).
If the user utterance matched a phrase in the focus grammar, the conversation 120 manager continues processing using the current process of execution of the application library, which continues using the same script to control the dialog (Step 308).
If the user utterance matched a phrase in the orienting grammar, the current and context of the conversation are stored in the context stack (Step 312).
The conversation manager looks up the matching goal category and then initiates a new script to satisfy that goal (Step 314). For example, if the user asks an unexpected but relevant question, the concept category of the question is matched which then maps to the script that is then executed to answer the question. A script may be an interpreted script or a compiled function designed to control the dialog to satisfy a particular goal.
The conversation manager replaces the current context with the new orienting context (Step 316) and then continues processing user utterance using the new script (Step 308). This allows the user to ask an unexpected question which is answered.
After the goal of the current context is fulfilled (Step 310), the virtual agent can ask the user if he wants to continue with previous topic of conversation (Step 318). If he does, then the current context is set to the previous context (Step 320) and processing of this context is continued (Step 308)
When all service goals are satisfied, the call is completed (Step 322).

In an alternative embodiment of the invention, the first application library is charged with initiating and communicating with additional application libraries if necessary.

By allowing both a focus and orienting response to users, the system can flexibly switch among many application libraries that complete transactions, resolve problems, answer questions and process “what-if” scenarios. If the speech grammars for the focus and orientation could reliably match most of the user's responses, this processing would be sufficient for flexible conversations.

However, because of the open-ended nature of flexible dialogs, reliably recognizing most of the user's responses, at today's level of commercial accuracy for directed dialogs, remains an issue. Because there are many ways of asking an unexpected, but relevant question there is a need for incorporating adaptive processing on the recognition errors. The recognition is significantly improved in one embodiment of the invention through the use of adaptive processing.

The issue of coverage may be partially resolved by requiring the user to say or ask utterances that are relevant to the current application and to the current topic of conversation at the moment. This means, for example, that if the application is “trading stocks”, the user cannot ask about “last night's baseball game.” It is estimated that at any given time there are about 5-40 reasonable types of questions that the user could possibly say or ask that are relevant to a current conversation topic.

### Adaptive Processing of Recognition Errors

Aspects of the present invention include the following two processes, which are referred to as Intelligent Conversation Response:
1. Process Recognition Errors: learning algorithms for inducing new speech grammars based on analyzing speech recognition errors; and
2. Induce New Grammars: syntactic and semantic analyses for mapping transcribed text, of unrecognized user utterances, to concepts of existing speech grammars.

One goal of one embodiment of the invention is for new speech grammars to be induced to correctly process future user utterances that caused previous speech recognition errors. In one embodiment of the invention, finite state grammars are used, and, once the correct grammars are induced to cover the wide range of possible user utterances, the recognition accuracy may closely match existing commercial levels for directed dialog. In an alternative embodiment of the invention, it may be preferable to limit the number of grammar phrases so as not to exceed the accuracy limit of today's speech recognition engine of about 5,000 phrases.

As described herein, “recognition” includes two phases of 1) utterance detection, and 2) mapping the utterance detection to a predetermined category or meaning. Thus, a recognition error may include a detection error or meaning error.

### Operation for Intelligent Conversation Response (ICR)

The flexibility of conversations for this effort is inspired, at least in part, by biological sensory systems in the brain, whereby one subsystem is used to focus on processing the attended stimulus and a second subsystem is used to orient to unexpected stimuli. As one embodiment of the conversational system listens to the next user utterance, there are two sets of speech grammars used to recognize what the user said. One grammar set, called the focus grammar, may be used to recognize a response to the previous virtual agent prompt and the other grammar set, known as the orienting grammar, may be used to recognize a selected number of possible questions or change of topics related to the current focus subject of the conversation.

The number of possible phrases in the orienting grammar may be limited to the current capacity of commercially available speech recognition engines using finite state grammars which is on the order of 5,000 distinguishing utterances. For one embodiment of the invention, the focus grammar may include no greater than 1,000 phrases and the orienting grammar typically includes no greater than about 20 requests expressed an average of 200 possible ways, which may be 4,000 phrases. Alternatively, it may also be 40 requests expressed in an average of 100 possible ways. The total upper end of both grammars combined should preferably be within the limit of current commercial speech recognition engines, which today is around 5,000. It should be understood, however, that the principles of the present invention are not limited by the capabilities of existing speech recognition engines and may apply to any number of speech grammars.

During a conversation, when a user is given a prompt, both the focus and orienting grammars are concurrently active, except when the service script executed by a processing application cannot be re-oriented, such as when asking a security question.

For example, if the prompt is “How many shares of IBM do you want to buy?” the focus grammar typically recognizes the number of shares. The orienting grammar may recognize any relevant question, for example: “How much cash do I have?” If the user says “10 shares,” the focus grammar may recognize it and continue with the next part of the script. However, if the user asks “How much cash do I have?” the orienting grammar may recognize it and then match that recognition with its associated goal. The matching goal is preferably mapped to a new script that may be executed to satisfy the goal, while the current script state may be pushed onto a script stack for later potential execution. In this example, the new script may find the answer to the question and respond “You have a cash balance of $10,000.”

At the end of the new script, for continuity, the new script may ask “Do you want to continue with stock trading?” At this point, the user has the option of continuing with the previous script on the script stack or changing to another topic. If the user decides to go to a new topic, the previous script on the stack may be deleted, but not the information gathered up to the interruption point. Even with the new script, the user may still interrupt its flow and change topics yet again.

FIG. 2 provides an illustration of a script stack where the script is associated with a particular topic or context. The stack may be a data structure that uses a last-in, first-out (LIFO) access methodology that is typically used for computer processor instructions. Another method of maintaining or controlling the context state or focus topic may be to use an array of scripts and a pointer or reference to the currently active script. Alternative methods of keeping the conversation state may be employed, as deemed appropriate by one of skill in the art.

One approach to create the accuracy robustness for flexibly spoken dialog processing is to automatically induce new speech grammars based on experience with many users through the processing of recognition errors.

### 1. Processing Recognition Errors:

Initially, for a flexible dialog in a speech application, a base set of finite state speech grammars for both the focus and orienting grammars may be coded. This coding is typically done manually, using the developer's prediction of what phrases callers are most likely to use. This predicted set of grammars is mapped to a preferably predetermined set of meaning categories that are each associated with script responses or script continuation.

One embodiment of the speech application may then be exposed to a sample audience of users who go through the flexible dialog. Because the base grammars cannot recognize some of the open-ended utterances spoken by these users, especially utterances for re-orienting the dialog, recognition errors are likely to be generated. As the system is exposed to many users, it is expected that, in most cases, correcting an error made by one person will result in inducing a new speech grammar that in the future may be used by another person.

One of the keys to inducing new speech grammars may be in processing these recognition errors. There are 2 types of recognition errors that can occur during an automated conversation:
The user says an utterance that does not match any speech grammar above the recognition threshold (false negative).
The user says an utterance that is recognized by a speech grammar but upon subsequent confirmation, the user invalidates the recognition (false positive).

On any given turn of conversation, one embodiment of the invention records the audio utterances of the user and registers each type of recognition error when it occurs. If the system cannot recognize what the user said or if the user invalidates a recognition more than twice, the system may transfer the dialog to a live service agent, which ends the automated dialog.

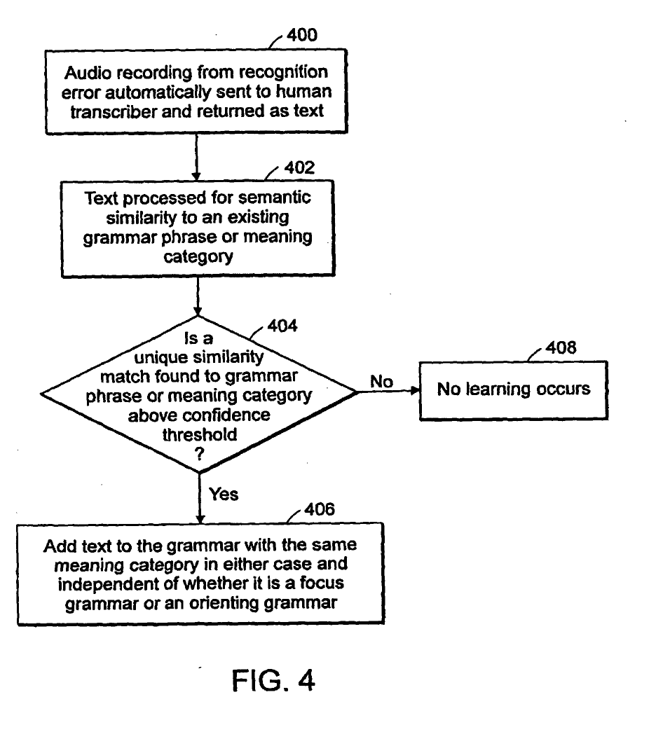

At the end of a batch of conversations, one embodiment of the invention may begin an off-line learning process on the recognition errors that led to any early dialog termination, in the batch of conversations. The errors may be processed, as shown in FIG. 4, by the following exemplary steps:
The audio recording of the utterances associated with the recognition errors are sent automatically to a human transcription service and then sent back in text (Step 400). Note that even though the transcription process is manual, the overall process is scheduled and totally automated, albeit off-line. This process includes registering the errors, sending out the audio files for transcription, scheduling the human transcription, receiving the transcription and processing the transcription into an updated flexible dialog.
The transcribed text is processed by semantic parsing and classification methods, described in the section on “Inducing New Grammars” below, to determine the best match to one meaning category from the set of meaning categories in the speech application (Step 402).
If the transcribed text is determined to be part of the conversation focus topic at the point the error occurred (Step 404), then the full transcribed text may be added to the list of phrases to be recognized for the focus speech grammar and its associated concept or meaning category at that point in the dialog (Step 406). In this way, if another user says the same utterance in the future that caused that particular error in the past, it may be recognized. For example, if the computer says “what is the problem with your phone?” and the user says “There is a hissing sound” and if that phrase was not in the list of expected responses of any grammar, a recognition error may occur. Once the user's utterance audio is transcribed, it is preferably semantically analyzed to determine if it is associated with either a focus goal concept or meaning category such as “static noise problem” which is one of the expected focus categories or another pre-existing focus grammar phrase like “There is static on the line.” Upon a semantic similarity match, the phrase “There is a hissing sound” may be added to the focus grammar within the concept or meaning category “static noise problem”.
However, if the transcribed text is determined to be part of a concept goal in the set of orienting phrases (Step 404), then it is added to list of phrases to be recognized for the orienting speech grammar along with the concept category it will be associated with (Step 406). For example, if the computer said “How many shares of IBM do you want to buy?” and the user said “Could you tell me how much cash I have?” and if that phrase was not in the list of any grammar, a recognition error occurs. Once the user's utterance audio is transcribed, it is preferably semantically analyzed to determine if it is associated with either an orienting goal concept such as “cash balance” which is one of the expected orienting categories or another pre-existing orienting grammar phrase like “What's my cash balance?” Upon a semantic match, the phrase “Could you tell me how much cash I have?” may be added to the orienting grammar within the concept category “cash balance.”
If there is no semantic match of the transcribed text to any dialog response or answer (Step 404), no further learning from the error occurs (Step 408). For example, if the computer says “How many shares of IBM do you want to buy?” and the user says “There is a hissing sound”, the transcribed text may not semantically match any dialog response or answer in a stock trading dialog and so, no learning occurs.

Semantic matching errors are discussed in the following section.

### 2. Inducing New Speech Grammars:

To induce new speech grammars, the transcribed text from recognition errors may be semantically analyzed to determine which speech grammar to induce and which concept the induced grammar may be a part of. A grammar concept is a unique semantic category that is mapped from potentially multiple utterances. For example the concept “yes” is mapped from the utterances “yes, OK, correct, that's right, right, you bet, you got it” and so on.

A number of assumptions and constraints are preferably in effect:
All the transaction processes, answers to questions, responses to users and grammar concepts for a speech application are predetermined and will remain fixed during the learning of new speech grammars. This is the same assumption made by many commercial solutions of virtual text chat.
Pronouns or other inferred references to knowledge and not explicit utterances in a previous turn of conversation or outside the meaning category set may or may not be processed.

The semantic analysis of the text proceeds in the following exemplary steps:
The raw text is analyzed for syntax and semantic parsing by the Connexor product Machinese or a functionally similar mechanism (Step 402).
All the possible word senses and definitions for each word are retrieved from WordNet or a like service, or remote or local tool with similar capabilities. WordNet a lexical tool from http://www.cogsci.princeton.edu/˜wn/. WordNet® is an online lexical reference system whose design is inspired by current psycholinguistic theories of human lexical memory. English nouns, verbs, adjectives and adverbs are organized into synonym sets, each representing one underlying lexical concept. Different relations link the synonym sets. WordNet was developed by the Cognitive Science Laboratory at Princeton University under the direction of Professor George A. Miller.
The semantic parsing of the text is matched against all the semantic parsing of both the existing grammar concepts or meanings and grammar phrases within the concepts to find the closest semantic match (Step 404). Multiple parallel methods of semantic matching may be used (See C. D. Manning, H. Schutze, Foundations of Statistical Natural Language Processing, MIT Press, Cambridge, Mass., 1999).

Here are a few examples of specific types of semantic matches:
The text: “I want to fly next week if that's available” may match an existing grammar phrase “I want to fly next week” with the concept “flight time”. In this case, the text will induce a new grammar to recognize this text within this concept.
The text: “I don't want to fly next week” may match an existing grammar phrase “avoid flying next week” with the concept “avoid flight time” closer than “I want to fly next week” because the analyzer would semantically match “not . . . fly” closer to “avoid flying” even though the syntax of the other phrase is closer.
The text: “There is a hissing sound on the line” may match the concept “static noise” because in WordNet the word “hissing” has the synonym “noise”.
Once matched, the text is used to add a new grammar phrase to the matched grammar concept (Step 406), so that in the future, when a user says that phrase, it will be recognized. If the text has multiple concepts then the induced grammar will have multiple speech grammar slots upon recognition.

The design of the analysis for inducing new grammars, as implemented by one of skill in the art, needs to address a number of issues to be robust:

The mapping of the text is preferably generalized. For example, the text “I want to buy 100 shares of IBM” needs to be both matched to a concept and generalized for key word classes. In this case, the match might be to an existing grammar phrase “TRADE_TYPE NUMBER shares of COMPANY” in the concept “trade stocks” where TRADE_TYPE, NUMBER and COMPANY are word list classes that already exist in the dialog knowledge base. A match to a word list class occurs when a word in the text, like “IBM”, matches to the same word in a word list class.

The entire learning process needs to be automated for new grammar induction to be successful. Otherwise this process may be both too difficult to use and too expensive. The automated classification need not be perfect. There may be some false positive and false negative matches.

The result of a false positive match is that the text induces a wrong speech recognition in the future. The incorrect recognition may be caught in the future as a recognized phrase that the user will invalidate upon confirmation.

The result of a false negative match is that no learning occurs for the text that should have induced a new grammar. Because learning is ongoing, new grammars that should have been learned but are not because of the false negative match at one moment will eventually be learned in the future. This effect is evident by taking the false negative match error to higher and higher power exponents. Eventually, the accumulated error probability may approach 0%.

Each text that is used to induce new grammars may have associated measurements such as the number of successful and unsuccessful future uses of the induced grammars. These measurements may allow another process to discard false positive errors of induced grammars.

With new induced grammars constantly being added as new users interact with the system, the growth of induced grammars may be limited to the size limitations of the commercial speech recognition engines. Just as the learning process adds new grammars, there needs to be another process to pare down unused or little used grammars. This process may discard obscure grammar phrases based on the measure of successful recognition use during the course of user interactions. Grammar phrases that have a low number of successful recognitions are deleted over time. The discarding of the grammar phrases prevents the build up of obscure grammar phrases that may reduce the recognition accuracy of other good grammar phrases.

It will be apparent to those of ordinary skill in the art that methods involved in the present invention may be embodied in a computer program product that includes a computer usable medium. For example, such a computer usable medium may consist of a read only memory device, such as a CD ROM disk or conventional ROM devices, or a random access memory, such as a hard drive device or a computer diskette, having a computer readable program code stored thereon.

While this invention has been particularly shown and described with references to preferred embodiments thereof, it will be understood by those skilled in the art that various changes in form and details may be made therein without departing from the scope of the invention.

What is claimed is:

1. A method of flexible dialog management in a speech recognition system, the method comprising:
receiving a spoken utterance from a user during an automated conversation between the user and a virtual agent;
attempting to recognize the spoken utterance with a phrase in an existing speech grammar;
if the spoken utterance fails to match a phrase in the speech grammar, resulting in a speech matching error, then processing the speech matching error by updating the speech grammar within one or more meaning categories to include an additional phrase that corresponds to a part or all of the spoken utterance.

2. The method of claim 1 wherein updating the speech grammar further comprises:
transcribing an audio recording of the spoken utterance to a textual representation;
semantically analyzing the textual representation to determine a meaning category corresponding to the textual representation;
mapping the textual representation to one or more of a predetermined set of meaning categories; and
adding a part or all of the textual representation of the spoken utterance in the corresponding meaning categories to the speech grammar.

3. The method of claim 2 wherein the speech grammar includes a focus grammar and an orienting grammar, the focus grammar being used to recognize one or more of expected responses mapped to one or more of expected meaning categories to a prompt from the virtual agent during the automated conversation with the user, the orienting grammar being used to recognize one or more of a set of questions or topic changes not covered by the focus grammar but related to the automated conversation.

4. The method of claim 3 wherein the textual representation of part or all of the unrecognized spoken utterance is added either to the focus grammar if the one or more meaning categories associated with the unrecognized spoken utterance corresponds to a current focus of the automated conversation at the time of the speech matching error or to the orienting grammar if the meaning category associated with the unrecognized spoken utterance corresponds to one or more meaning categories associated the orienting grammar.

5. A speech recognition system with flexible dialog management, said system comprising:
a communication interface receiving an utterance from a user during an automated conversation between the user and a virtual agent;
a stored speech grammar;
a speech recognition module attempting to recognize the utterance with a phrase in the stored speech grammar;
a learning module processing a speech matching error in case of a failure in matching a phrase in the stored speech grammar by updating the stored speech grammar within one or more meaning categories to include an additional phrase that corresponds to a part or all of the utterance.

6. The speech recognition system of claim 5, wherein the learning module further comprises:
a transcriber transcribing an audio recording of the utterance to a textual representation;
a semantic analyzer analyzing the textual representation to determine a meaning category corresponding to the textual representation;
a mapping of the textual representation to one or more of a predetermine set of meaning categories; and
a new speech grammar comprising the stored speech grammar and an added part or all of the textual representation of the utterance in the corresponding meaning category.

7. The speech recognition system of claim 6, wherein the stored speech grammar includes a focus grammar and an orienting grammar, the focus grammar being used to recognize one or more of expected responses mapped to one or more of expected meaning categories to a prompt from the virtual agent during the automated conversation with the user, the orienting grammar being used to recognize one or more of a set of questions or topic changes not covered by the focus grammar but related to the automated conversation.

8. The speech recognition system of claim 7, wherein the textual representation of part or all of the unrecognized utterance is added either to the focus grammar if the one or more meaning categories associated with the unrecognized spoken utterance corresponds to a current focus of the automated conversation at the time of the speech matching error or to the orienting grammar if the meaning category associated with the unrecognized spoken utterance corresponds to one or more meaning categories associated the orienting grammar.

9. A content readable medium storing instructions for flexible dialog management in a speech recognition system, said instructions comprising:
instructions for receiving a spoken utterance from a user during an automated conversation between the user and a virtual agent;
instructions for attempting to recognize the spoken utterance with a phrase in an existing speech grammar;
instructions for, if the spoken utterance fails to match a phrase in the speech grammar, resulting in a speech matching error, then processing the speech matching error by updating the speech grammar within one or more meaning categories to include an additional phrase that corresponds to a part or all of the spoken utterance.

10. A method of flexible dialog management in a speech recognition system, the method comprising:
conducting an automated conversation between a user and a virtual agent according to a first script to satisfy a first goal associated with a meaning category of a speech grammar;
receiving a spoken utterance from the user;
attempting to recognize the spoken utterance with a phrase in a focus grammar and an orienting grammar, the focus grammar being used to recognize one of responses to a prompt from the virtual agent, the orienting grammar being used to recognize one of a set of questions or topic change commands not covered by the focus grammar but related to a subject of the automated conversation;
if the recognized utterance matches a phrase in the orienting grammar, storing the first script for the automated conversation in memory;
determining a second goal associated with the matched phrase in the orienting grammar;
conducting the automated conversation between the user and the virtual agent according to a second script to satisfy the second goal.

11. The method of claim 10 further comprising:
after satisfying the second goal, querying the user whether to continue processing the first script; and if so, retrieving the first script for the conversation from the memory; and
continuing to conduct the automated conversation between the user and the virtual agent according to the first script to satisfy the first goal.

12. The method of claim 10 wherein if the recognized utterance matches a phrase in the focus grammar, the method further comprises:
continuing to conduct the automated conversation between the user and the virtual agent according to the first script to satisfy the first goal.

13. The method of claim 10 wherein the speech grammar is a finite state grammar or a statistical language model grammar.

14. A speech recognition system with flexible dialog management, said system comprising:
an application conducting an automated conversation between a user and a virtual agent according to a first script to satisfy a first goal associated with a meaning category of a speech grammar;
focus grammar used to recognize one of responses to a prompt from the virtual agent;
orienting grammar used to recognize one of a set of questions or topic change commands related to a subject of the automated conversation;
a communication engine receiving a spoken utterance from the user; and
if the received spoken utterance matches a phrase in the orienting grammar, said system further comprising:
a memory storing the first script for the automated conversation if the received spoken utterance matches a phrase in the orienting grammar;
the application conducting the automated conversation between the user and the virtual agent according to a second script to satisfy a second goal.

15. The system of claim 14, wherein the speech grammar is a finite state grammar or a statistical language model grammar.

16. A content readable medium storing instructions for flexible dialog management in a speech recognition system, said instructions comprising:
instructions for conducting an automated conversation between a user and a virtual agent according to a first script to satisfy a first goal associated with a meaning category of a speech grammar;
instructions for receiving a spoken utterance from the user;
instructions for attempting to recognize the spoken utterance with a phrase in a focus grammar and an orienting grammar, the focus grammar being used to recognize one of responses to a prompt from the virtual agent, the orienting grammar being used to recognize one of a set of questions or topic change commands related to a subject of the automated conversation;
if the recognized utterance matches a phrase in the orienting grammar,
instructions for storing the first script for the automated conversation in memory;
instructions for determining a second goal associated with the matched phrase in the orienting grammar;
instructions for conducting the automated conversation between the user and the virtual agent according to a second script to satisfy the second goal.

17. The content readable medium of claim 16, further comprising:
instructions for, after satisfying the second goal, querying the user whether to continue processing the first script; and if so,
instructions for retrieving the first script for the conversation from the memory; and
instructions for continuing to conduct the automated conversation between the user and the virtual agent according to the first script to satisfy the first goal.

18. The content readable medium of claim 16 wherein if the recognized utterance matches a phrase in the focus grammar, the instructions further comprise:
instructions for continuing to conduct the automated conversation between the user and the virtual agent according to the first script to satisfy the first goal.

19. The content readable medium of claim 16 wherein the speech grammar is a finite state grammar or a statistical language model grammar.
